(19) United States
(12) Patent Application Publication
(10) Pub. No.: US 2009/0003631 A1
(43) Pub. Date: Jan. 1, 2009

(54) Condenser Microphone

(75) Inventors: Toshiro Izuchi, Kurate-gun (JP); Noriaki Hanada, Kurate-gun (JP); Ryuji Awamura, Kurate-gun (JP); Tsuyoshi Baba, Kurate-gun (JP)

Correspondence Address: THE WEBB LAW FIRM, P.C., 700 KOPPERS BUILDING, 436 SEVENTH AVENUE, PITTSBURGH, PA, 15219, US

(73) Assignee: HOSIDEN CORPORATION, Osaka (JP)

(21) Appl. No.: 12/143,212

(22) Filed: Jun. 20, 2008

(30) Foreign Application Priority Data
Jun. 25, 2007 (JP) 2007-166410

(51) Int. Cl. H04R 1/00; H04R 25/00

(52) U.S. Cl. 381/174

(57) ABSTRACT

A condenser microphone comprises a casing body formed from a combination of a first plate member defining a top surface, a second plate member defining a bottom surface and an intermediate member provided between the first plate member and the second plate member, the top surface having an acoustic hole formed therein, a capacitor section including a diaphragm electrode, a fixed electrode, and an electret membrane provided in the diaphragm electrode or the fixed electrode, a converting circuit section for converting variations of capacitance of the capacitor section into electric signals for output, a conductive section for making the capacitor section electrically conductive with the converting circuit section, and conductive surface terminal elements extending from the top surface through side surfaces to the bottom surface among outer surfaces of the casing body to be conductive with the converting circuit section. The capacitor section, the converting circuit section and the conductive section are mounted inside the casing body.

### BACKGROUND OF THE INVENTION

1. Field of the Invention

The present invention relates to a condenser microphone, and more particularly to a condenser microphone comprising a casing body having an acoustic hole formed in a top surface thereof, a capacitor section including a diaphragm electrode, a fixed electrode and an electret membrane provided on the diaphragm electrode or the fixed electrode, a converting circuit section for converting variations of the capacitance of the capacitor section to electric signals for output, and a conductive section for making the capacitor section electrically conductive with the converting circuit section, in which the capacitor section, the converting circuit section and the conductive section are mounted inside the casing body.

2. Description of the Related Art

In mounting the condenser microphone of the above-noted type on mobile devices such as mobile phones, the condenser microphone is generally mounted on a circuit board provided in such a mobile device using solder or the like. More particularly, a surface terminal element exposed from the surface of the casing body of the condenser microphone is joined to an electrode pattern on the circuit board using solder.

As the mobile devices are miniaturized, the shape and the arrangement of the circuit board in the mobile device are restricted in various ways. This requires a versatile method of mounting the condenser microphone on the circuit board.

Japanese Unexamined Patent Publication No. 2007-81614 discloses a condenser microphone comprising a casing body having an acoustic hole formed in a top surface thereof, a capacitor section including a diaphragm electrode, a fixed electrode and an electret membrane formed on the diaphragm electrode or the fixed electrode, a converting circuit section for converting variations of the capacitance of the capacitor section to electric signals for output, and a conductive section for making the capacitor section electrically conductive with the converting circuit section, in which the capacitor section, the converting circuit section and the conductive section are mounted inside the casing body. Further, in such a condenser microphone, part of the top surface is conductive with part of the bottom surface, and a terminal element conductive with the converting circuit section extends through the interior of the casing body. As a result, the condenser microphone in accordance with this reference allows the top surface of the casing body to be joined to the circuit board and also allows the bottom surface of the casing body to be joined to the circuit board, which provides a versatile mounting method for the condenser microphone.

However, according to the condenser microphone of Japanese Unexamined Patent Publication No. 2007-81614, the top surface or the bottom surface of the casing body is joined to the circuit board by solder, and thus the solder is concealed in the casing body after the joint is completed. More particularly, the solder cannot be visually observed after the joint is completed, which leads to a drawback that the operator cannot visually confirm whether or not the soldered joint has properly been formed. Further, since the solder is provided between the casing body and the circuit board, it becomes difficult to heat the solder when a necessity arises to melt the solder again to remove the condenser microphone from the circuit board.

### SUMMARY OF THE INVENTION

The present invention has been made having regard to the above-noted problems, and its object is to provide a condenser microphone that is versatile with respect to a mounting method and convenient in mounting and removing the same.

In order to achieve the above-noted object, a characteristic feature of the condenser microphone in accordance with the present invention lies in comprising:

a casing body formed from a combination of a first plate member defining a top surface, a second plate member defining a bottom surface and an intermediate member provided between the first plate member and the second plate member, the top surface having an acoustic hole formed therein;

a capacitor section including a diaphragm electrode, a fixed electrode, and an electret membrane provided in the diaphragm electrode or the fixed electrode;

a converting circuit section for converting variations of capacitance of the capacitor section into electric signals for output;

a conductive section for making the capacitor section electrically conductive with the converting circuit section; and

conductive surface terminal elements extending from the top surface through side surfaces to the bottom surface among outer surfaces of the casing body to be conductive with the converting circuit section,

wherein the capacitor section, the converting circuit section and the conductive section are mounted inside the casing body.

With the above-noted construction, when the surface terminal elements of the casing body are joined to the circuit board using solder, the solder can be provided, in a relatively large amount, not only between the casing body and the circuit board but also on the side surfaces of the casing body where the surface terminal elements are formed. Therefore, the mounting condition of the solder can be visually confirmed with ease after the joint is completed. Also, if the solder is not properly provided, the solder can be remolten using a soldering iron.

Further, since the surface terminal elements are formed on side surfaces of the casing body as well, the casing body can be mounted on the circuit board even in a positional relationship where one of the side surfaces of the casing body faces to the circuit board.

Thus, the condenser microphone provided is versatile in a mounting method of the same and convenient in mounting and removing the same.

Another characteristic feature of the condenser microphone in accordance with the present invention lies in that a joining member is provided around the acoustic hole of the top surface to be joined to a circuit board.

With the above-noted construction, it is possible to form a through bore in the circuit board and to join the joining member to the circuit board using solder or any other adhesive with the through bore being aligned with the acoustic hole of the casing body, thereby joining the top surface of the casing body of the condenser microphone to the circuit board. More particularly, the joint between the joining member and the circuit board can prevent a gap being produced between a region around the acoustic hole of the casing body and the circuit board. As a result, sounds can be prevented from traveling around from boundary surfaces between the region around the acoustic hole of the casing body and the circuit board to enter the acoustic hole. Instead, only sounds passing through the through bore formed in the circuit board can enter the interior of the casing body through the acoustic hole.

A further characteristic feature of the condenser microphone in accordance with the present invention lies in that conductive portions are provided in boundary surfaces between the first plate member, the intermediate member and the second plate member joined to one another, respectively.

With the above-noted construction, the first plate member, the intermediate member and the second plate member are made conductive with one another reliably.

A still further characteristic feature of the condenser microphone in accordance with the present invention lies in that the first plate member, the intermediate member and the second plate member are joined to one another through a conductive adhesive.

With the above-noted construction, the first plate member, the intermediate member and the second plate member can be rigidly joined to one another, while securing a reliable conductive state among these members.

### BRIEF DESCRIPTION OF THE DRAWINGS

FIG. 1 is a perspective view of a condenser microphone;

FIG. 2 is a sectional view of the condenser microphone taken along line II-II of FIG. 1;

FIG. 3 is an exploded perspective view of the condenser microphone;

FIG. 4 is another exploded perspective view of the condenser microphone;

FIG. 5 is an explanatory view showing a way of mounting the condenser microphone on a circuit board;

FIG. 6(a) is a schematic sectional view showing a state where the condenser microphone in accordance with the present invention is mounted on the circuit board;

FIG. 6(b) is a schematic sectional view showing a state where a conventional condenser microphone is mounted on the circuit board;

FIG. 7 is a perspective view of a condenser microphone in accordance with another embodiment; and

FIG. 8 is a perspective view of a condenser microphone in accordance with a further embodiment.

### DETAILED DESCRIPTION OF THE PREFERRED EMBODIMENT

A condenser microphone M in accordance with the present invention will described hereinafter with reference to the accompanying drawings.

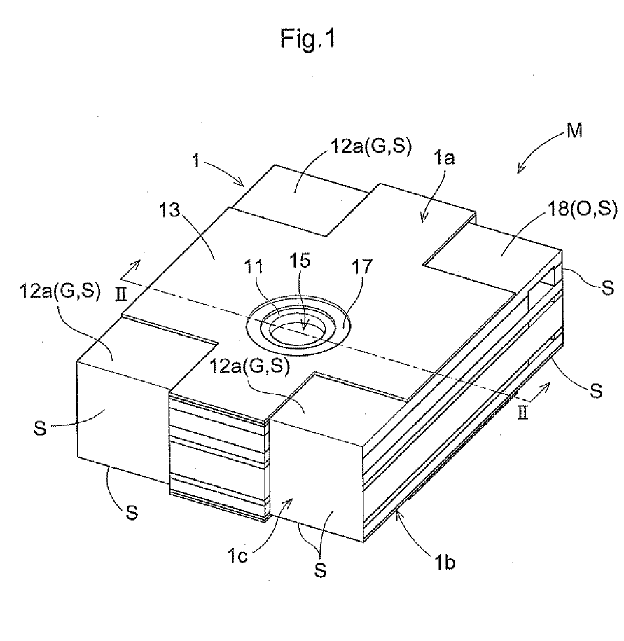

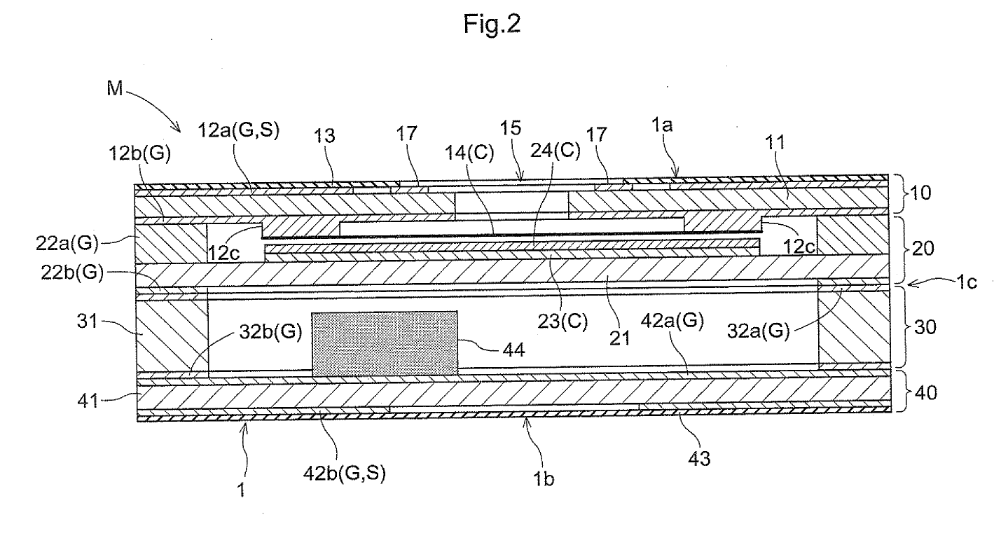

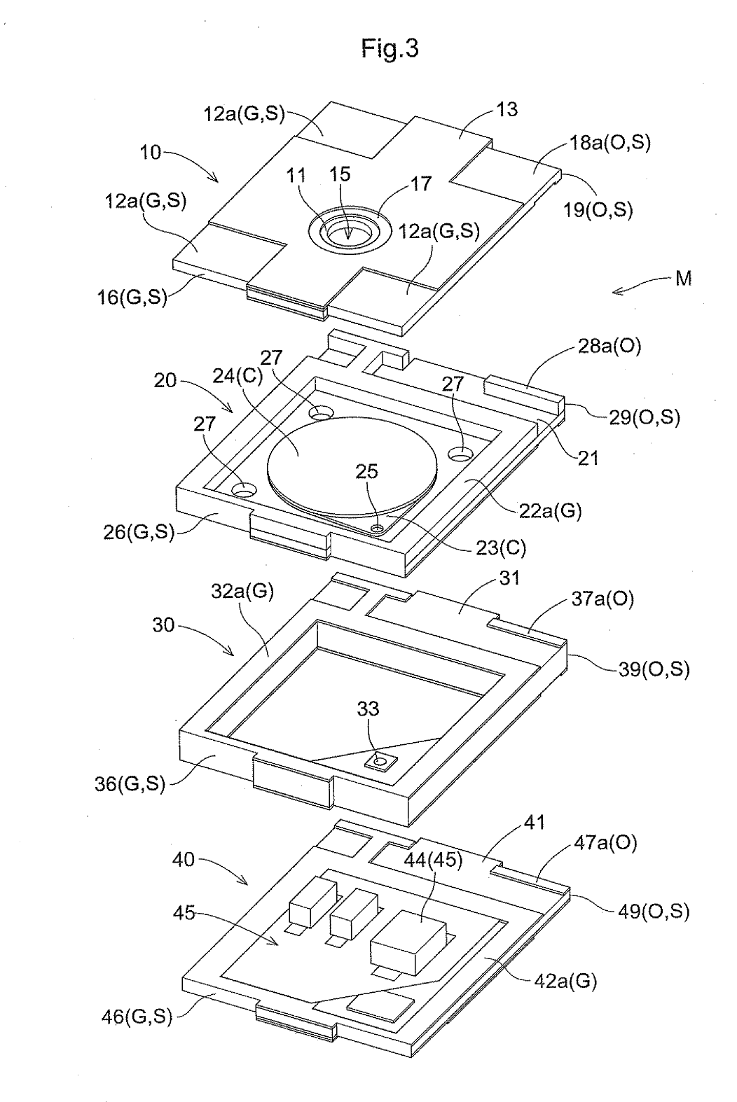

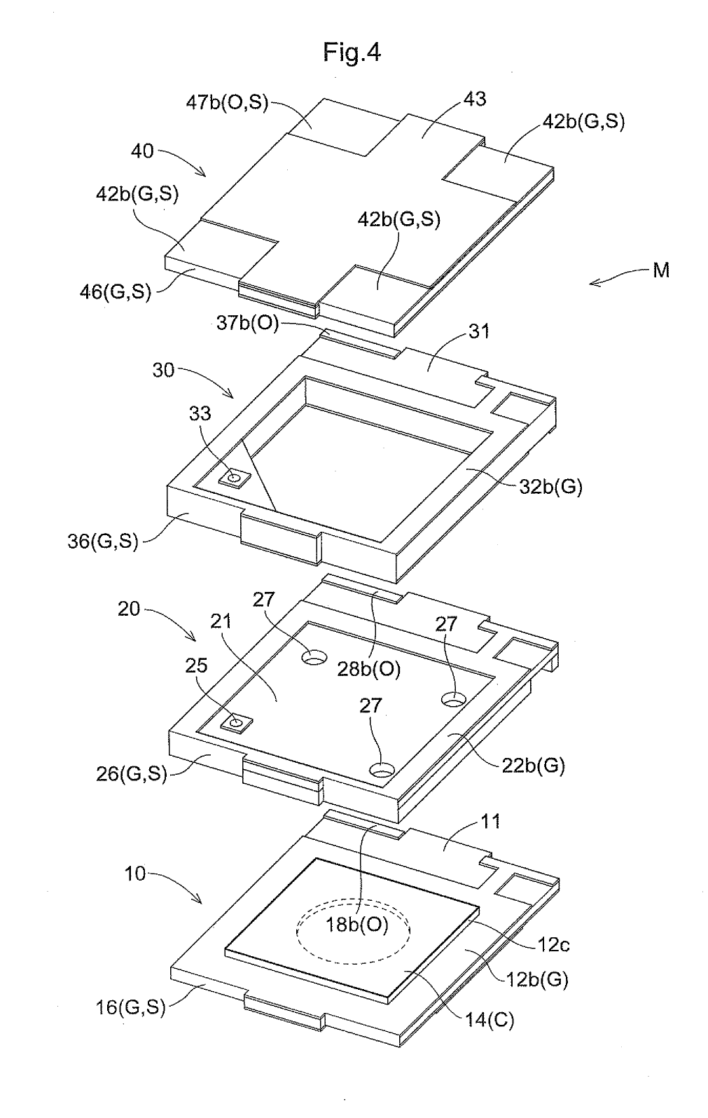

FIG. 1 is a perspective view of the condenser microphone M, and FIG. 2 is a sectional view of the condenser microphone M taken along line II-II of FIG. 1, and more particularly along a short axis of the condenser microphone M. FIG. 3 is an exploded perspective view of the condenser microphone M seen from a top surface 1a of a casing body 1, and FIG. 4 is an exploded perspective view of the condenser microphone M seen from a bottom surface 1b of the casing body 1. As shown in FIGS. 1 through 4, the condenser microphone M in accordance with the present invention comprises the casing body 1 having an acoustic hole 15 formed in the top surface 1a, a capacitor section C including a diaphragm electrode 14, a fixed electrode 23 and an electret membrane 24 formed on the diaphragm electrode 14 or fixed electrode 23, a converting circuit section 45 for converting variations of the capacitance of the capacitor section C into electric signals for output, and a conductive section for making the capacitor section C electrically conductive with the converting circuit section 45. The capacitor section C, converting circuit section 45 and conductive section are mounted inside the casing body 1. More particularly, the rectangular casing body 1 of the condenser microphone M includes a first layer 10 acting as a first rectangular plate member forming the top surface 1a of the casing body 1, a second layer 20 acting as a rectangular intermediate member, a third layer 30 also acting as a rectangular intermediate member, and a fourth layer 40 acting as a second rectangular plate member forming the bottom surface 1b of the casing body 1. While this embodiment gives an example where the intermediate member includes two layers, i.e. the second layer 20 and third layer 30, the intermediate member may include only one element or three or more. The electret membrane 24 may be provided on the diaphragm electrode 14.

The first layer 10 includes the acoustic hole 15 and diaphragm electrode 14 of the condenser microphone M. More particularly, an insulating first base member 11 includes first conductive portions 12a and 18a, and a first insulating portion 13 mounted in the mentioned order on the side adjacent the top surface 1a. It should be noted that the first conductive portions 12a as shown are electrically conductive with each other while the first conductive portions 12a and the first conductive portion 18a are separated and electrically insulated from each other. The first base member 11 includes a first conductive portion 12b and the diaphragm electrode 14 laminated in the mentioned order on the side opposed to the bottom surface 1b, and a first conductive portion 18b formed on this side. It should be noted that the first conductive portion 12b and the diaphragm electrode 14 are electrically conductive with each other while the first conductive portion 12b and the first conductive portion 18b are separated and electrically insulated from each other.

The first base member 11 includes the circular acoustic hole 15 formed therein. The surface of the first base member 11 remains annularly exposed around the acoustic hole 15 adjacent the top surface 1a. As described later, the first conductive portions 12a act as ground terminal element G and surface terminal element S, while the first conductive portion 18a acts as an output terminal element O and the surface terminal S of the condenser microphone M. Around the acoustic hole 15 is formed an annular exposed portion 17 to surround the exposed surface of the first base member 11.

The first insulating portion 13 surrounds the exposed portion 17 noted above and covers parts of the first conductive portions 12a and the first conductive portion 18a. The first insulating portion 13 has a cross shape centering on the acoustic hole 15. Therefore, in the four corners of the top surface 1a of the casing body 1, the first conductive portions 12a are exposed at three corners while the first conductive portion 18a is exposed at one corner.

The first conductive portion 12b formed peripherally of the first base member 11 on the side opposed to the bottom surface 1b acts as the ground terminal element G, and has a projection 12c protruding toward the side away from the first base member 11. The projection 12c has a rectangular flat portion at a distal end thereof to which the diaphragm electrode 14 having the same size as the projection is joined. The projection 12c has a circular aperture having the same diameter as the acoustic hole 15 in the side contacting the first base member 11 to allow sounds to enter the interior of the casing body 1 from the outside of the casing body 1 through the aperture. The projection 12c opens toward the bottom surface 1b to define a cylindrical space having an inner diameter larger than that of the aperture. The diaphragm electrode 14 is joined to the projection to cover the opening, using a conductive adhesive. Thus, the diaphragm electrode 14 can vibrate within the cylindrical space defined by the projection 12c.

The second layer 20 includes the fixed electrode 23 and the electret membrane 24 arranged in a central portion of an insulating second base member 21 in the mentioned order to be opposed to the projection 12c and the diaphragm electrode 14. The second base member 21 includes, formed peripherally on the side adjacent the top surface 1a, a second conductive portion 22a for contacting the first conductive portion 12b, and a second conductive portion 28a for contacting the first conductive portion 18b. In this embodiment, the first conductive portion 12b and the second conductive portion 22a are joined to each other, and the first conductive portion 18b and the second conductive portion 28a are joined to each other, by the conductive adhesive, respectively. As a result, the diaphragm electrode 14 of the first layer 10 and the fixed electrode 23 and the electret membrane 24 of the second layer 20 constitute the capacitor section C of the condenser microphone M of the present invention. The gap between the diaphragm electrode 14 and the electret membrane 24 is adjusted by the thickness of the first conductive portions 12b and 18b, the thickness of the second conductive portions 22a and 28a and the thickness of the conductive adhesive.

A second conductive portion 22b is formed peripherally of the second base member 21 on the side adjacent the bottom surface 1b, while a second conductive portion 28b is formed in a position remote from the second conductive portion 22b to be electrically insulated from the second conductive portion 22b. As described later, the second conductive portions 22a and 22b act as the ground terminal element G while the second conducive portions 28a and 28b act as the output terminal element O.

The third layer 30 includes an insulating third base member 31. The third base member 31 includes, formed on the side opposed to the top surface 1a, a third conductive portion 32a having the same shape as the second conductive portion 22b and contacting the second conductive portion 22b, and a third conductive portion 37a having the same shape as the second conductive portion 28b and contacting the second conductive portion 28b. The second conductive portion 22b and the third conductive portion 32a are joined to each other, and the second conductive portion 28b and the third conductive portion 37a are joined to each other, by the conductive adhesive, respectively. The third base member 31 includes, on the side adjacent the bottom surface 1b, a third conductive portion 32b formed peripherally thereof, and a third conductive portion 37b formed in a position remote from the third conductive portion 32b to be electrically insulated from the third conductive portion 32b.

As described later, the third conductive portions 32a and 32b act as the ground terminal element G while the third conductive portions 37a and 37b act as the output terminal element O.

The fourth layer 40 includes an insulating fourth base member 41. The fourth base member 41 includes, formed on the side opposed to the top surface 1a, a fourth conductive portion 42a having the same shape as the third conductive portion 32b and contacting the third conductive portion 32b, and a fourth conductive portion 47a having the same shape as the third conductive portion 37b and contacting the third conductive portion 37b. The third conductive portion 32b and the fourth conductive portion 42a are joined to each other, and the third conductive portion 37b and the fourth conductive portion 47a are joined to each other, by the conductive adhesive, respectively. The fourth conductive portion 42a is conductive with a circuit pattern of the converting circuit section 45 for converting variations of the capacitance of the capacitor section C to electric signals for output. Various elements such as an FET 44 forming part of the converting circuit section 45 are mounted on the circuit pattern.

The fourth base member 41 includes, formed on the side adjacent the bottom surface 1b, fourth conductive portions 42b and 47b and a fourth insulating portion 43 which are formed in the mentioned order. It should be noted that the fourth conductive portions 42b and the fourth conductive portion 47b are separated and electrically insulated from each other. The fourth insulating portion 43 has a cross shape. Therefore, in the four corners of the bottom surface 1b of the casing body 1, the fourth conductive portions 42b are exposed at three corners while the fourth conductive portion 47b is exposed at one corner.

As shown in FIGS. 1, 3 and 4, the first layer 10, second layer 20, third layer 30 and fourth layer 40 include side surfaces 1c defining end surfaces perpendicular to a long axis of the casing body 1. The side surfaces 1c have conductive side surface terminals 16, 26, 36 and 46 acting as the ground terminal element G which are electrically conductive with each other, and side surface terminals 19, 29, 39 and 49 acting as the output terminal element O which are electrically conductive with each other. Thus, the first conductive portions 12a, side surface terminal 16, first conductive portion 12b, second conductive portion 22a, side surface terminal 26, second conductive portion 22b, third conductive portion 32a, side surface terminal 36, third conductive portion 32b, fourth conductive portion 42a, side surface terminal 46 and fourth conductive portions 42b are electrically conductive with one another. The first conductive portions 12a, side surface terminals 16, 26, 36 and 46 and fourth conductive portions 42b exposed on the surfaces of the casing body 1 constitute the surface terminal element S (ground terminal element G) as a whole extending from the top surface 1a through the side surface 1c to the bottom surface 1b. The first conductive portion 18a, side surface terminal 19, first conductive portion 18b, second conductive portion 28a, side surface terminal 29, second conductive portion 28b, third conductive portion 37a, side surface terminal 39, third conductive portion 37b, fourth conductive portion 47a, side surface terminal 49 and fourth conductive portion 47b are electrically conductive with one another. The first conductive portion 18a, side surface terminals 19, 29, 39 and 49 and fourth conductive portion 47b exposed on the surface of the casing body 1 constitute the surface terminal element S (output terminal element O) as a whole extending from the top surface 1a through the side surface 1c to the bottom surface 1b. The ground terminal element G and the output terminal element O are connected to the converting circuit section 45, respectively.

The fixed electrode 23 provided in the second layer 20 includes a through hole 25 formed therein to contact a through hole 33 formed in the third layer 30. The through hole 33 in turn contacts the converting circuit section 45 provided on the fourth layer 40. Therefore, the fixed electrode 23 of the second layer 20 is electrically conductive with the FET 44. The diaphragm electrode 14 provided on the first layer 10 is electrically conductive with the FET 44 through the surface terminal element S noted above. In other words, the capacitor section C is electronically connected to the FET 44. Thus, the diaphragm electrode 14 is vibrated by sounds entering from the acoustic hole 15, and variations of the capacitance of the capacitor section C are transmitted to the converting circuit section 45 having the FET 44 to be converted into electric signals and outputted from the converting circuit section 45 to the output terminal element O. As noted above, the through hole 33 formed in the third layer 30 acts as the conductive section for making the capacitor section C (the fixed electrode 23 and the electret membrane 24) electrically conductive with the converting circuit section 45.

A plurality of through bores 27 are formed in the second base member 21 of the second layer 20. The space between the first layer 10 and the second layer 20 and the space between the second layer 20 and the fourth layer 40 communicate with each other through the plurality of through bores 27 extending from the second layer 20 toward the third layer 30. The air present in those spaces is able to circulate in response to vibrations of the diaphragm electrode 14. Thus, the provision of the plurality of through bores 27 improves the vibration property of the diaphragm electrode 14 to facilitate its vibration.

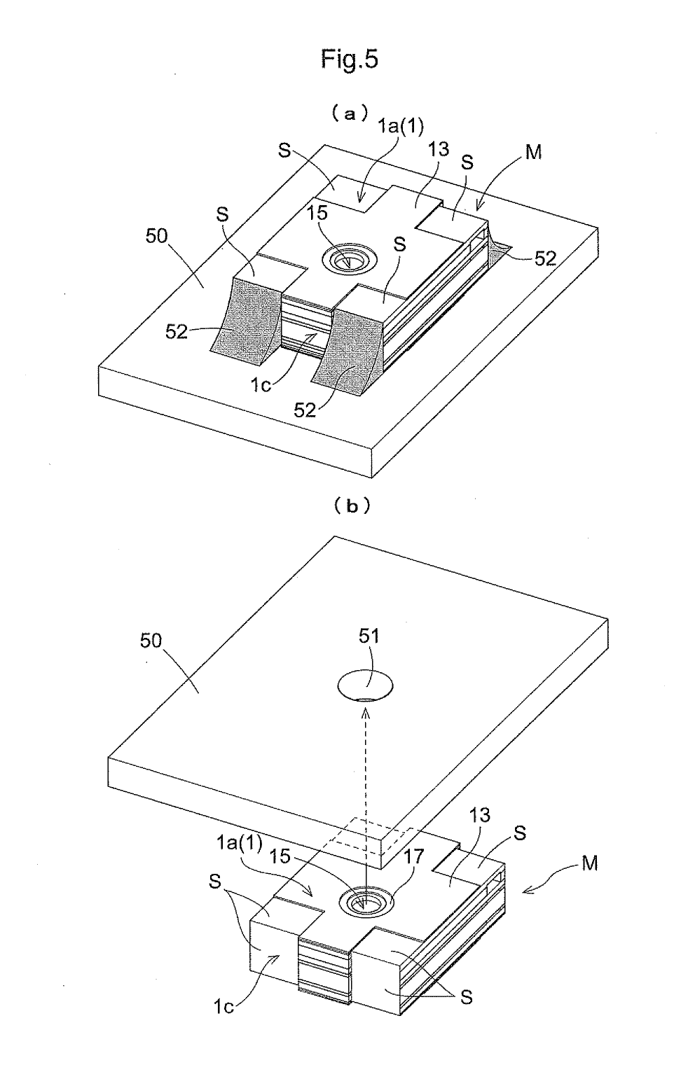

FIG. 5(a) is an explanatory view showing a way of joining the casing body 1 of the condenser microphone M to a circuit board 50 at the bottom surface 1b. As shown, the condenser microphone M is jointed to the circuit board 50 by solder 52. The condenser microphone M in accordance with the present invention includes the surface terminal element S extending over the top surface 1a, the side surfaces 1c and the bottom surface 1b of the casing body 1, and thus a joining method can be employed in which a relatively large amount of solder 52 is provided on the side surfaces 1c of the casing body 1. The surface terminal element S includes two kinds of elements, the ground terminal element G and the output terminal element O. Therefore, it is easy to visually confirm the mounting condition of the solder after adhesion with the solder. Further, a large contacting area can be secured between the solder 52 and the casing body 1, which allows the condenser microphone M to be firmly joined to the circuit board 50. The ground terminal element G acting as the surface terminal element S provided on the top surface 1a, side surfaces 1c and bottom surface 1b of the casing body 1 also acts as an electromagnetic shield for the interior of the casing body 1.

FIG. 5(b) is an explanatory view showing a way of joining the casing body 1 of the condenser microphone M to the circuit board 50 at the top surface 1a. As shown, a through bore 51 formed in the circuit board 50 is aligned with the acoustic hole 15 of the casing body 1 to allow the exposed portion 17 formed in the top surface 1a of the casing body 1 of the condenser microphone M to be joined to the circuit board 50 using the solder. In short, the exposed portion 17 acts as a joint member. Therefore, no gap is produced between the region around the acoustic hole 15 of the casing body 1 and the circuit board 50. This prevents sounds from entering the acoustic hole 15 through an interface between the region around the acoustic hole 15 of the casing body 1 and the circuit board 50. Only sounds passing through the through bore 51 formed in the circuit board 50 are allowed to enter the interior of the casing body 1.

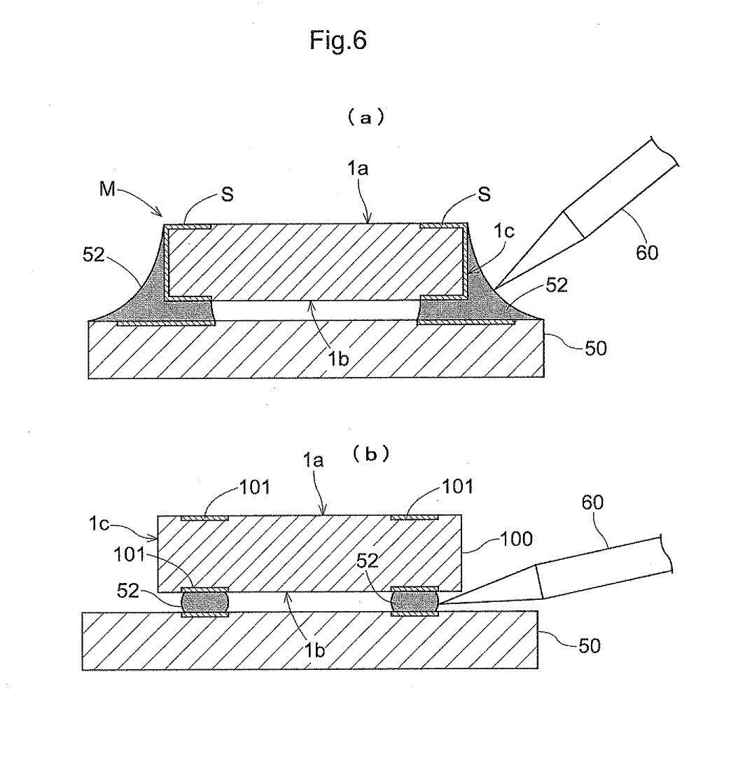

FIG. 6(a) is a schematic sectional view showing a state where the condenser microphone M in accordance with the present invention is mounted on the circuit board 50, while FIG. 6(b) is a schematic sectional view showing a state where a conventional condenser microphone is mounted on the circuit board 50.

As shown in FIG. 6(a), according to the present invention, since a relatively large amount of solder 52 can be provided on the side surfaces 1c of the casing body 1, it is easy to remelt the solder 52 using a soldering iron 60 when the solder 52 is not mounted properly.

On the other hand, as shown in FIG. 6(b), the conventional condenser microphone has surface terminal elements 101 not provided on the side surfaces 1c, but provided only on the bottom surface 1b and the top surface 1a of a casing body 100. As a result, it is hard to confirm the mounting condition of solder 52 since the solder 52 contributing to the joint between the casing body 100 and the circuit board 50 is provided in positions difficult to visually recognize from outside. Further, the solder 52 is provided in inward positions between the casing body 100 and the circuit board 50, and thus the soldering iron 60 does not easily reach the solder 52, which makes it difficult to remelt the solder 52.

### Other Embodiments

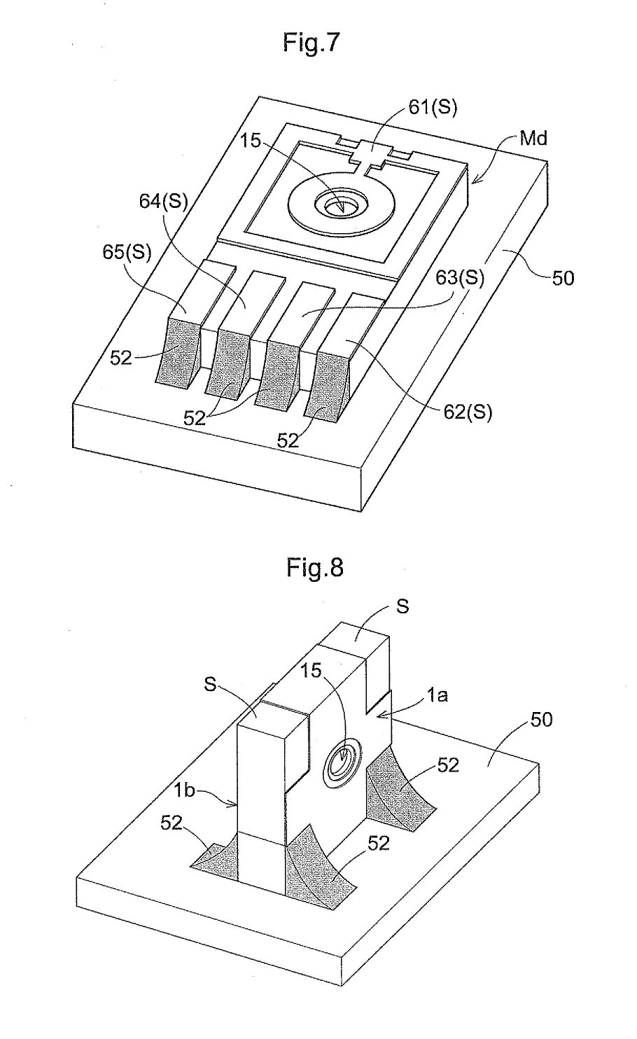

(1) The present invention may be applied to various types of condenser microphone. For example, the invention can be applied to a condenser microphone of the digital output type. FIG. 7 is a perspective view of a condenser microphone Md in accordance with a modified embodiment. In this condenser microphone Md, a surface terminal element S connected to a converting circuit section (not shown) includes a ground terminal 61, a source terminal 62, an output terminal 63, a clock terminal 64 and an SEL terminal 65, all of which are provided extending over a top surface, side surfaces and a bottom surface among outer surfaces of a casing body in a way similar to the foregoing embodiment. The condenser microphone Md shown in FIG. 7 is different from the condenser microphone M of the foregoing embodiment only in the construction of the surface terminal element S and the construction of the converting circuit section connected to the surface terminal element S. Other constructions are the same as in the foregoing embodiment.
(2) In the foregoing embodiment, the top surface 1a or the bottom surface 1b of the condenser microphone is joined to the circuit board 50 as shown in FIG. 5. The condenser microphone may be joined to the circuit board in other ways. FIG. 8 is a perspective view of a condenser microphone in accordance with a further modified embodiment. In this embodiment, the condenser microphone is joined to the circuit board 50 at the side surface thereof where the surface terminal element S is provided.
(3) In the foregoing embodiments, the respective layers (respect elements) are joined by the conductive adhesive. Instead, these may be joined by pressure connection or welding of conductive portions provided on boundary surfaces of the respective layers (respective elements).

What is claimed is:

1. A condenser microphone comprising:
a casing body formed from a combination of a first plate member defining a top surface, a second plate member defining a bottom surface and an intermediate member provided between the first plate member and the second plate member, the top surface having an acoustic hole formed therein;
a capacitor section including a diaphragm electrode, a fixed electrode, and an electret membrane provided on the diaphragm electrode or the fixed electrode;
a converting circuit section for converting variations of capacitance of the capacitor section into electric signals for output;
a conductive section for making the capacitor section electrically conductive with the converting circuit section; and
conductive surface terminal elements extending from the top surface through side surfaces to the bottom surface among outer surfaces of the casing body to be conductive with the converting circuit section,
wherein the capacitor section, the converting circuit section and the conductive section are mounted inside the casing body.

2. A condenser microphone as claimed in claim 1, wherein conductive portions are provided on boundary surfaces between the first plate member, the intermediate member and the second plate member joined to one another, respectively.

3. A condenser microphone as claimed in claim 2, wherein the first plate member, the intermediate member and the second plate member are joined to one another through a conductive adhesive.

4. A condenser microphone as claimed in claim 1, wherein a joining member is provided around the acoustic hole of the top surface to be joined to a circuit board.

5. A condenser microphone as claimed in claim 4, wherein conductive portions are provided on boundary surfaces between the first plate member, the intermediate member and the second plate member joined to one another, respectively.

6. A condenser microphone as claimed in claim 5, wherein the first plate member, the intermediate member and the second plate member are joined to one another through a conductive adhesive.
